(19) United States
(12) Patent Application Publication
(10) Pub. No.: US 2009/0205189 A1
(43) Pub. Date: Aug. 20, 2009

(54) MANUFACTURE OF FIXED TIP CATHETERS

(75) Inventors: Shekhar D. Nimkar, Swampscott, MA (US); Eric Tobin, North Andover, MA (US)

Correspondence Address: NUTTER MCCLENNEN & FISH LLP, WORLD TRADE CENTER WEST, 155 SEAPORT BOULEVARD, BOSTON, MA, 02210-2604, US

(73) Assignee: SPIRE CORPORATION, Bedford, MA (US)

(21) Appl. No.: 12/244,559

(22) Filed: Oct. 2, 2008

Related U.S. Application Data
(60) Provisional application No. 61/029,051, filed on Feb. 15, 2008.

(51) Int. Cl. B23P 19/04; B23P 11/00

(52) U.S. Cl. 29/460; 29/428

(57) ABSTRACT

Methods of forming catheters are disclosed, together with methods of forming fixed tip catheters. In one aspect of the invention, the manufacturing methods can include the steps of: providing first and second catheter tubes, a distal end of the first catheter tube extending a longitudinal length beyond a distal end of the second catheter tube, and attaching a flow diverting structure to an outside surface of the first catheter tube between the distal ends of the first and second catheter tubes. The flow diverting structure can be oriented on the first catheter tube to divert fluid flowing through an inner lumen of the second catheter tube.

### CROSS REFERENCE TO RELATED APPLICATIONS

The present application claims the priority of U.S. Provisional Application Ser. No. 61/029,051 filed Feb. 15, 2008 entitled “Manufacture of Fixed Tip Catheters,” which is herein incorporated by reference in its entirety. This application is also related to commonly owned U.S. patent application Ser. No. ______ filed concurrently herewith entitled “Catheters With Enlarged Arterial Lumens” (Attorney Docket No. 101430-238), U.S. patent application Ser. No. ______ filed concurrently herewith entitled “Fusion Manufacture of Multi-Lumen Catheters” (Attorney Docket No. 101430-236), and U.S. patent application Ser. No. ______ filed concurrently herewith entitled “Manufacture of Split Tip Catheters” (Attorney Docket No. 101430-234), each of which are herein incorporated by reference in their entireties.

### BACKGROUND

The present invention generally relates to catheters and preferably to multi-lumen catheters used for vascular access.

Multi-lumen catheters are desirable for various treatment applications such as hemodialysis where fluid extraction and return occur simultaneously. Hemodialysis is the separation of metabolic waste products and water from the blood by filtration. Typically, a hemodialysis unit is connected to a patient's body by a catheter. The catheter's distal end is placed in a blood vessel and its proximal end is connected to a hemodialysis unit.

During hemodialysis, a patient's blood typically flows through a double lumen catheter to the hemodialysis unit which provides filtration and controls the flow of blood. A double lumen catheter has two lumens that independently allow fluid extraction and return. For example, one lumen can be used for removing blood from a patient for processing in the hemodialysis machine and the other lumen can be used for subsequently returning the processed blood back to the patient's circulatory system. Such catheters can also include additional lumens for flushing, administration of anticoagulants or the like.

Parameters that can be varied to achieve adequate hemodialysis include blood flow rate, dialysis solution flow rate, and dialyzer competency. Generally, raising the blood flow rate increases dialysis efficiency. However, conditions such as access recirculation decrease efficiency. Access recirculation is the recirculation of treated blood back into the hemodialysis unit. Excess recirculation effectively reduces dialysis efficiency and lengthens the duration of the treatment needed for adequate dialysis. Access recirculation can be particularly of concern when using a double lumen catheter due to the close proximity of the intake and outflow ports at the distal tip of the catheter.

Various double lumen catheter designs have been suggested for the purpose of reducing access recirculation. For example, in so-called “staggered, fixed tip” designs, the distal ends of intake and outflow lumens can be longitudinally spaced 20-30 mm apart to prevent recirculation. For example, Twardowski et al. U.S. Pat. No. 5,569,182 discloses that the lumen for return of blood back into the vein should terminate beyond the extraction lumen. The purpose of this is to prevent cleansed blood, exiting from the outlet point of the catheter, from re-entering the catheter's blood inlet point and returning to the dialysis machine. However, certain disadvantages have been noted by such large longitudinal spacing between the distal ends of the respective lumens. For example, blood flow stagnation in the region of the blood vessel between two widely separated tips can lead to clot formation.

In addition to longitudinal spacing of the distal openings of the lumens, others have suggested that the distal end of a multi-lumen catheter can be split such that the distal tip segments can independently move in the blood vessel to optimize the fluid dynamics of the different functions (blood extraction and blood return). However, split tip catheters can be more difficult to insert into a target blood vessel than fixed tip designs.

There exists a need for better staggered, fixed tip catheter designs that can further reduce blood recirculation and/or low stagnation while maintaining good flow rates and other physical and mechanical properties of the catheter, for instance tensile strength and kink-resistance, as well as overall catheter dimensions small enough for insertion and proper physiological function.

While various techniques are known for manufacturing catheters, there exists a need for more efficient and economical techniques, especially in manufacturing catheters when the distal openings of the lumens are longitudinally spaced or a different shape or geometry is desired for one or the other of the lumens or tip segments.

### SUMMARY OF THE INVENTION

Methods of forming catheters are disclosed, together with methods of forming fixed tip catheters. In one aspect of the invention, the manufacturing methods can include the steps of: providing first and second catheter tubes, a distal end of the first catheter tube extending a longitudinal length beyond a distal end of the second catheter tube, and attaching a flow diverting structure to an outside surface of the first catheter tube between the distal ends of the first and second catheter tubes.

The flow diverting structure can be attached to the first catheter tube in a variety of ways. For example, the diverting structure can be fused or glued to the first catheter tube.

The flow diverting structure can have a variety of shapes, sizes, and configurations. For example, the flow diverting structure can be oriented on the first catheter tube to intersect a longitudinal axis of the second catheter tube. For another example, the flow diverting structure can have a diameter that does not exceed a diameter of the second catheter tube.

The flow diverting structure can be composed of a variety of materials. For example, the diverting structure can be composed of a material different than a material of the first catheter tube, such as a material with a durometer that differs from that of the first catheter tube.

The first and second catheter tubes can also have a variety of shapes, sizes, and configurations. For example, lumens of the first and second inner catheter tubes each have double D-shaped configurations. For another example, the first and second inner catheter tubes have different cross-sectional areas and/or different cross-sectional shapes.

In some embodiments, the method can include forming at least one fluid passage hole in a side of each of the catheter tubes. In another aspect, at least a portion of the first catheter tube can be coated with at least one agent selected from the group of antithrombotic agents, antibacterial agents, anti-inflammatory agents.

In another aspect of the invention, a method of forming a fixed tip catheter is disclosed including the steps of: providing an elongate catheter body comprising at least a first inner lumen and a second inner lumen extending longitudinally through the catheter body, removing a distal portion of the catheter body to form a first lumen tip segment such that the first inner lumen extends longitudinally beyond a distal end of the second inner lumen, and attaching a flow diverting structure to an outside surface of the first lumen tip segment.

The flow diverting structure can be attached to the first lumen tip segment in a variety of ways. For example, the diverting structure can be fused or glued to the first lumen tip segment.

The flow diverting structure can have a variety of shapes, sizes, and configurations. For example, the flow diverting structure can be attached on the first lumen tip segment a distance from the distal end of the second inner lumen. For another example, the flow diverting structure can be oriented on the outside surface of the first lumen to intersect a longitudinal axis of the second inner lumen.

A distal portion of the catheter body can be removed in a variety of ways, such as by partially slicing the catheter body in a non-perpendicular direction with respect to a longitudinal axis of the catheter body. In some embodiments, removing the distal portion of the catheter body includes truncating the catheter body at a truncation point such that at least a portion of the septum is retained by the first lumen tip segment.

In still another aspect of the invention, a method of forming a fixed tip catheter is disclosed including the steps of: splitting a distal end of a catheter body having two or more lumens at a septum dividing two of the lumens to isolate a first distal end lumen tube, truncating the catheter body such that the first distal end lumen tube is formed and has a length that extends beyond a truncation point, and attaching at a distance beyond the truncation point a flow diverting structure to at least a portion of the septum retained on the first distal end lumen tube. In some embodiments, the method further includes truncating the distal end of the catheter body to isolate a third lumen.

In yet another aspect of the invention, a method of forming a fixed tip catheter is disclosed including the steps of: removing a partial length of a tube included in a catheter body to expose a septum between the tube and another tube included in the catheter body, wherein each tube defines a separate fluid pathway extending longitudinally through the catheter body, and attaching a flow diverting structure to the septum such that the flow diverting structure is configured to divert fluid flowing through the pathway of the tube that was partially removed. The tubes can have the same or different cross-sectional areas.

The flow diverting structure can be attached to the septum in a variety of ways and in a variety of configurations. For example, the flow diverting structure can be attached a distance from a distal end of the tube that was partially removed. For another example, the flow diverting structure can be oriented on the septum to intersect a longitudinal axis of the fluid pathway of the tube that was partially removed.

In still another aspect of the invention, a method of forming a fixed tip catheter is disclosed including the steps of: providing a first catheter tube having a substantially D-shaped cross-section and a second catheter tube having a substantially D-shaped cross-section, attaching at least a portion of longitudinal lengths of the first catheter tube and the second catheter tube along flat surfaces of the first catheter tube and the second catheter tube to form a dual lumen catheter assembly such that the first catheter tube extends longitudinally beyond the second catheter tube, and attaching a flow diverting structure to a portion of the flat surface of the first catheter tube that extends longitudinally beyond the second catheter tube.

The flow diverting structure can be attached to the first catheter tube in a variety of ways and in a variety of configurations. For example, the flow diverting structure can be attached a distance from a distal end of the second catheter tube. For another example, the flow diverting structure can be oriented on the first catheter tube to intersect a longitudinal axis of the second catheter tube.

Attaching a portion of longitudinal lengths of the first and second catheter tubes can be performed in a variety of ways. For example, the first and second catheter tubes can be heat bonded and/or adhesive or chemical reaction bonded. In some embodiments, the tubes can be fused together along at least about 70% of the longitudinal length of at least one of the tubes.

In some embodiments, the method includes removing a portion of the assembly to form a first lumen tip segment such that the first catheter tube extends longitudinally beyond the second catheter tube. In another aspect, the method can include fusing together two tubes of different longitudinal lengths such that the first catheter tube extends longitudinally beyond the second catheter tube. In another aspect, the method can include encasing the assembly to smoothen any irregularities along the attached portion of the longitudinal lengths.

In still another aspect of the invention, a method of forming a fixed tip catheter is disclosed including the steps of: providing first and second catheter tubes each having a cross-section including at least one substantially flat-sided surface, attaching at least a portion of the substantially flat-sided surfaces together to form a catheter assembly such that a distal portion of the first catheter tube extends beyond a distal portion of the second catheter tube when their substantially flat-sided surfaces are attached, and attaching a flow diverting structure to a portion of the substantially flat-sided surface of the distal portion of the first catheter tube.

The flow diverting structure can be attached to the first catheter tube in a variety of ways and in a variety of configurations. For example, the flow diverting structure can be attached a distance from a distal end of the second catheter tube. For another example, the flow diverting structure can be oriented on the first catheter tube to intersect a longitudinal axis of the second catheter tube.

Attaching a portion of the substantially flat-sided surfaces together can be performed in a variety of ways. For example, the first and second catheter tubes can be heat bonded and/or adhesive or chemical reaction bonded.

In some embodiments, the method can further include encasing the catheter assembly to smoothen any irregularities along the attached surfaces.

In still another aspect of the invention, a method of forming a fixed tip catheter is disclosed including the steps of: attaching two tubes together along at least a portion of substantially flat surfaces of respective longitudinal lengths of the tubes, orienting the tubes such that a distal portion of one tube extends longitudinally beyond a distal portion of the other tube, and attaching a flow diverting structure to an outside surface of the distal portion of the tube that extends longitudinally beyond the distal portion of the other tube.

The two tubes can be attached together in a variety of ways. For example, the tubes cab be attached along substantially planar edges of respective D-shaped cross-sections of the tubes. In some embodiments, the tubes can be fused together along at least about 70% of the longitudinal length of at least one of the tubes.

In some embodiments, the method can further include allowing proximal portions of the tubes to remain unattached from each other. In other aspects, the method can include fusing together two tubes of different longitudinal lengths such that the distal portion of one tube extends longitudinally beyond the distal portion of the other tube.

Other advantages and features will become apparent from the following description and from the claims.

### BRIEF DESCRIPTION OF THE DRAWINGS

The invention will be more fully understood from the following detailed description taken in conjunction with the accompanying drawings, in which like reference numerals designate like parts throughout the figures, and wherein:

FIG. 1 is a schematic view of two tubes and a flow diverting structure in an initial, unattached configuration;

FIG. 2 is a schematic view of an embodiment of the present invention showing a multi-lumen catheter having a flow diverting structure attached thereto;

FIG. 3 is a schematic view of another embodiment of the present invention showing a multi-lumen catheter having a split tip proximal end;

FIG. 4 is a partial cutaway, side view of another embodiment of the present invention showing a multi-lumen catheter having a flow diverting structure attached thereto;

FIG. 5 is a top view of the multi-lumen catheter of FIG. 4;

FIG. 6 is a schematic view of an embodiment of the present invention showing a catheter including differently shaped lumens;

FIG. 7 is a cross-section view of an embodiment of the present invention showing a catheter construction utilizing opposed D-shaped lumens;

FIG. 8 is a cross-section view of a variation of the embodiment of FIG. 7 showing opposed D-shaped lumens of different cross-sectional areas;

FIG. 9 is a cross-section view of an embodiment of the present invention showing a catheter construction with two individual circular lumens;

FIG. 10 is a cross-section view of an embodiment of the present invention showing an oval-shaped catheter construction;

FIG. 11 is a cross-section view of an embodiment of the present invention showing a catheter construction with three lumens;

FIG. 12 is a cross-section view of a variation of another embodiment of the present invention showing a catheter construction with three lumens;

FIG. 13 is a cross-section view of an embodiment of the present invention showing a catheter construction utilizing a D-shaped lumen and a D-shaped flow diverting structure;

FIG. 14 is a cross-section view of an embodiment of the present invention showing a catheter construction with a circular lumen and a D-shaped flow diverting structure;

FIG. 15 is a cross-section view of an embodiment of the present invention showing a variation of a catheter construction with a circular lumen and a D-shaped flow diverting structure;

FIG. 16 is a cross-section view of an embodiment of the present invention showing a catheter construction with two lumens and a flow diverting structure;

FIG. 17 is a cross-section view of an embodiment of the present invention showing a catheter construction utilizing two D-shaped lumens and a D-shaped flow diverting structure;

FIG. 18 is a cross-section view of an embodiment of the present invention showing a catheter construction with a circular lumen and an arced flow diverting structure;

FIG. 19 is a schematic view of two tubes in an initial, unattached configuration;

FIG. 20 is a schematic view of an embodiment of the present invention showing a multi-lumen catheter having staggered ends;

FIG. 21 is a schematic, partially cutaway, side view of a catheter according to the present invention;

FIG. 22 is a cross-section view of an embodiment of the present invention showing a catheter construction formed from opposed D-shaped lumen bodies inside an outer sheath;

FIG. 23 is a cross-section view of an embodiment of the present invention showing a catheter construction formed from two individual tubes with circular lumens inside an outer sheath;

FIG. 24 is a schematic, perspective view of two lumen tubes in an initial, pre-trimmed configuration;

FIG. 25 is a schematic, perspective view of an embodiment of the present invention showing two lumen tubes and a flow diverting structure attached to one of the tubes;

FIG. 26 is a schematic, perspective view of a variation of an embodiment of the present invention showing two lumen tubes and a flow diverting structure attached to one of the tubes;

FIG. 27 is a schematic, perspective view of a variation of two lumen tubes in an initial, pre-trimmed configuration;

FIG. 28 is a schematic, perspective view of a variation of an embodiment of the present invention showing two lumen tubes and a flow diverting structure attached to one of the tubes;

FIG. 29 is a schematic, perspective view of a catheter in an initial, pre-trimmed configuration;

FIG. 30 is a schematic, perspective view of another catheter in an initial, pre-trimmed configuration;

FIG. 31 is a cross-section view of a catheter assembly including three lumens; and

FIG. 32 is a cross-section view of a variation of an embodiment of the present invention showing a multi-lumen catheter having a flow diverting structure attached thereto.

### DETAILED DESCRIPTION

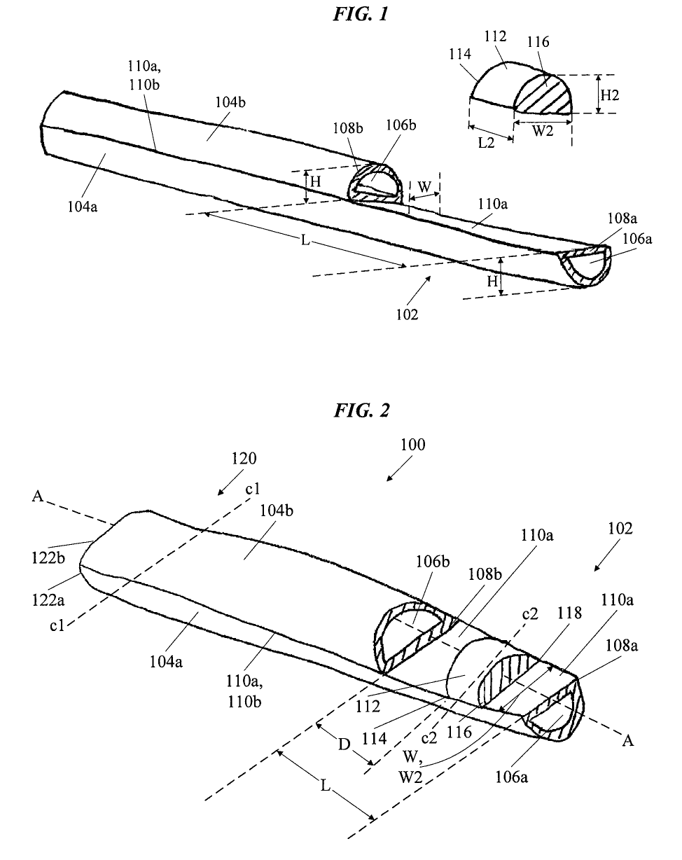

FIG. 1 shows first and second catheter tubes or bodies 104a, 104b (collectively, the tubes or bodies 104) and a flow diverting structure 112 in an initial, unattached configuration (e.g., prior to the diverting structure's attachment to one of the tubes 104). The tubes 104 include respective inner lumen pathways 106a, 106b (collectively, the pathways 106) extending longitudinally through the tubes 104 for, e.g., the extraction or return of blood or other bodily fluids. The first tube 104a (also referred to as “the longer tube 104a”) includes a distal tip portion 102 having a distal end 108a that extends a longitudinal length L beyond a distal end 108b of the second tube 104b (also referred to as “the shorter tube 104b”). The distal ends 108a, 108b (collectively, the distal ends 108) of the lumens 104 can be open to provide fluid passageways through the pathways 106, e.g., for blood removal and return. Each of the tubes 104 in this illustrated embodiment has a substantially D-shaped cross-section and at least one substantially flat surface (e.g., facing or contacting surfaces 110a, 110b (collectively, the facing or contacting surfaces 110)). The tubes 104 can, however, have different cross-sectional shapes. Although the tubes 104 are shown having equal widths W and equal diameters or heights H, the tubes 104 can have different widths and/or different diameters.

The diverting structure 112 can have any shape and size. The diverting structure 112 is shown having a width W2 that equals the width W of the tubes 104, but the diverting structure's width W2 can be greater than, less than, or equal to the width of either or both the tubes 104. Similarly, the diverting structure 112 is shown having a diameter or height H2 that equals the diameter H of the tubes 104, but the diverting structure's diameter H2 can be greater than, less than, or equal to the diameter of either or both the tubes 104. The diameter H2 of the diverting structure 112 can vary along a length L2 of the diverting structure 112 and/or along the width W2 of the diverting structure 112, e.g., if the diverting structure 112 has a non-perpendicular edge at either or both of its proximal and distal ends 114, 116, has a D-shaped cross-sectional shape (as shown in FIG. 1), includes one or more depressions and/or one or more protrusions anywhere on its surface, etc. Whether the diameter H2 of the diverting structure 112 varies or remains constant along the length L2 and/or the width W2, a maximum value of the diameter H2 can be equal to or less than the diameter H of the shorter tube 104b, a configuration that can allow for easier insertion of the tubes 104 and the diverting structure 112 into the body when the diverting structure 112 has been attached to the longer tube 104a because the diverting structure 112 does not exceed the height H of the shorter tube 104b. As mentioned above, the diverting structure 112 as shown has a D-shaped cross-section having a constant area along the length L2 of the diverting structure 112, but the diverting structure 112 can have any cross-sectional shape, and its cross-sectional shape can change along its longitudinal length L2. The diverting structure 112 can be solid or include one or more hollow cavities. Moreover, the diverting structure 112 can have a smooth outside surface, a textured outside surface, or a combination of both.

In FIG. 2, an embodiment of a fixed tip catheter assembly 100 includes the tubes 104 and the diverting structure 112 of FIG. 1, with the diverting structure 112 having been attached to one of the tubes 104. (As used throughout, “the catheter assembly” and its components refers to the various embodiments of the present invention.) The catheter assembly 100 is typically a very flexible silicone, polyurethane, or other biocompatible composition (e.g., having a stiffness in the range of about 65 to about 85 durometer), and can be fabricated into any type of catheter (e.g., a hemodialysis catheter or a central venous catheter).

The flow diverting structure 112 has been attached to an outside surface of the longer tube 104a between the tubes' distal ends 108a, 108b, e.g., on the longer tube's facing surface 110a in the distal tip portion 102. Examples of the diverting structure 112 are disclosed in Siegel, Jr. et al. U.S. Pat. No. 6,409,700. The diverting structure 112 can be attached anywhere on the longer tube 104a such that the diverting structure 112 is oriented to divert fluid flowing out of the pathway 106a at the distal end 108a of the longer tube 104a away from the pathway 106b at the distal end 108b of the shorter tube 108b. For example, the diverting structure 112 can be attached on the facing surface 110a of the longer tube 104a to intersect a longitudinal axis A of the shorter lumen tube 104b. In this way, the diverting structure 112 can at least partially obscure a predicted path of fluid flowing into the distal end 108b of the shorter lumen 104b. The diverting structure 112 is typically attached so its proximal end 114 is a distance D (see FIGS. 2 and 4) from the distal end 108b of the shorter tube 104b so as to provide adequate space for fluid to flow into the shorter tube 104b. The distance D can have any positive value less than the length L between the distal ends 108 of the tubes 104. The length L can be in the range of about 0.5-3 inches, which is a preferable, but only an example, length of the distal tip portion 102.

The diverting structure 112 can be attached to the longer tube 104a in a variety of ways. For example, in one embodiment, the diverting structure 112 can be fused to the longer tube 104a along at least a portion of a substantially flat surface (e.g., a facing or contacting surface 118) of the diverting structure 112 and along at least a portion of an outside surface of the longer tube 104a (e.g., on the facing surface 110a along a portion of the length L). Any fusion technique can be used, e.g., thermal fusion where elements to be joined (here, facing surfaces 110a, 118 of the longer tube 104a and the diverting structure 112, respectively) are heated along any or all portions of their perimeters or other areas to a desired temperature and fused together by application of a desired force and allowing them to melt/cool together. In another example embodiment, the diverting structure 112 and the longer tube 104a can be attached together using a gluing technique, e.g., applying a bonding material such as an adhesive to one or more of the elements to be bonded and, if necessary, heating the bonding material to bond it to the elements. In some embodiments, the catheter assembly 100 can be formed using any combination of heat fusion and gluing techniques.

The diverting structure 112 can be made of any biocompatible material which allows it to maintain structural integrity when in contact with flowing fluid, such as when inserted in a blood vessel during hemodialysis. The diverting structure's material can be the same as or different from that of the longer tube 104a. Using a different material for the diverting structure 112 (e.g., a harder material having a higher durometer) can help create a more predictable fluid flow path by reducing chances of the diverting structure 112 flexing, bending, or otherwise distorting when being inserted into a fluid flow path (e.g., a blood vessel) and when fluid flows against the diverting structure 112.

The tubes 104 can be made of any biocompatible material (same as or different from the material of the diverting structure 112), including any material which allows the distal tip portion 102 of the longer tube 104a to be flexible and facilitate hemodialysis. The pathways 106 are preferably sized to allow the carrying of blood to and from a hemodialysis unit, although the pathways 106 can be any size, and the catheter assembly 100 can be used in any application. Furthermore, although the pathways 106 are shown as having equal cross-sectional areas in the embodiment illustrated in FIG. 2, the pathways 106 can have different cross-sectional areas.

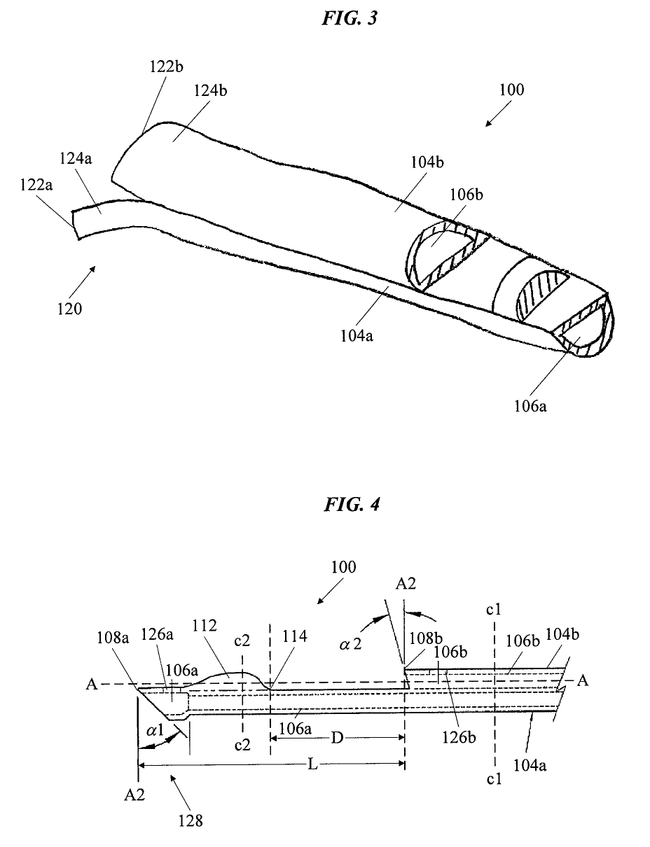

A proximal portion 120 of the catheter assembly 100 has a fixed tip where proximal ends 122a, 122b (collectively, the proximal ends 122) of the first and second tubes 104, respectively, are fixed together. However, as shown in FIG. 3, the proximal portion 120 can include a split tip in which the tubes 104 separate into two proximal lumen tip segments, 124a, 124b (collectively, the proximal lumen tips 118). The proximal ends 122 of the tubes 104 can be open to provide fluid passageways through the pathways 106, e.g., for blood removal and return.

The distal ends 108 of the tubes 104 can each have any angle α1, α2 with respect to the transverse axes A2 of the tubes 104. The values of the angles α1, α2 can be the same or different. In the embodiment illustrated in FIG. 4, the longer tube 104a has an angle α1 equal to forty-five degrees, while the shorter tube 104a has an angle α2 equal to fifteen degrees. If the tubes 104 have beveled edges (e.g., if the angles α1, α2 are each above zero degrees but less than ninety degrees), the tubes 104 can be easier to insert into a body lumen.

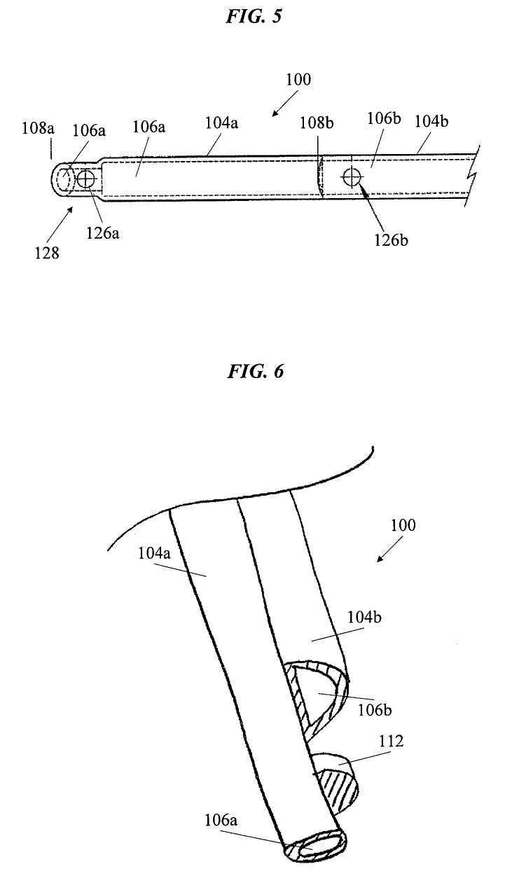

As shown in FIGS. 4 and 5, the first and second tubes 104a, 104b can optionally each include first and second holes 126a, 126b (collectively, the holes 126) in their respective surfaces and in communication with their respective pathways 106a, 106b. Although only one hole 126 is shown in each of the tubes 104, the tubes 104 can each include one or more holes 126 (if the tubes 104 include any at all). When the catheter assembly 100 is in use, the holes 126 can help relieve pressure and reduce clogging in the pathways 106. The holes 126 can also aid in inserting the catheter assembly 100 into a body lumen using a guidewire. A guidewire can be threaded into the first tube's pathway 106a at the distal end 108a, out of the first tube 104a through the first hole 126a, and into the second tube's pathway 106b through the second hole 126b. So threaded in the tubes 104, the catheter assembly 100 can be inserted over the guidewire into a body lumen.

The tubes 104 can have a variety of cross-sectional shapes and sizes but preferably, as shown in the embodiments of FIGS. 2 and 4, the catheter assembly 100 has a substantially elliptical (circular or oval) shape and the tubes 104 are each substantially D-shaped. Similarly, in the embodiments of FIGS. 4 and 5, the catheter assembly 100 has a substantially elliptical (circular or oval) shape and the tubes 104 are each substantially circular. However, one or both of the tubes 104 can transition from one shape to another along at least a portion of its length, e.g., transition from a D-shaped cross-section to a circular cross-section. For example, as shown in FIGS. 4 and 5, the longer tube 104a has a D-shaped cross-section and D-shaped pathway 106a except in a distal portion 128 which has a circular-shaped cross-section and a circular-shaped pathway 106a. Having a circular-shaped distal portion with a rounded end, as shown, can allow for easier insertion of the longer tube 104a into a body lumen. The distal portion 128 can be a lumen tip segment that has been joined to the longer tube 104a such that the pathway of the longer tube 104a is in communication with the pathway of the lumen tip segment, thereby forming a single pathway 106a through the longer tube 104a and the distal portion's lumen tip segment. The lumen tip segment can be joined to the longer tube 104a in a variety of ways. For example, the lumen tip segment can be fused and/or bonded to the longer tube 104a. Any fusion technique and/or bonding technique can be used, such as those described above. In some embodiments, the lumen tip segment can be attached in such a way as to provide a gradual transition between the luminal walls of the longer tube 104a and the luminal walls of the lumen tip segment, for instance via the insertion of a mandrel and the application of heat. The lumen tip segment can also be formed from part of the longer tube 104a itself.

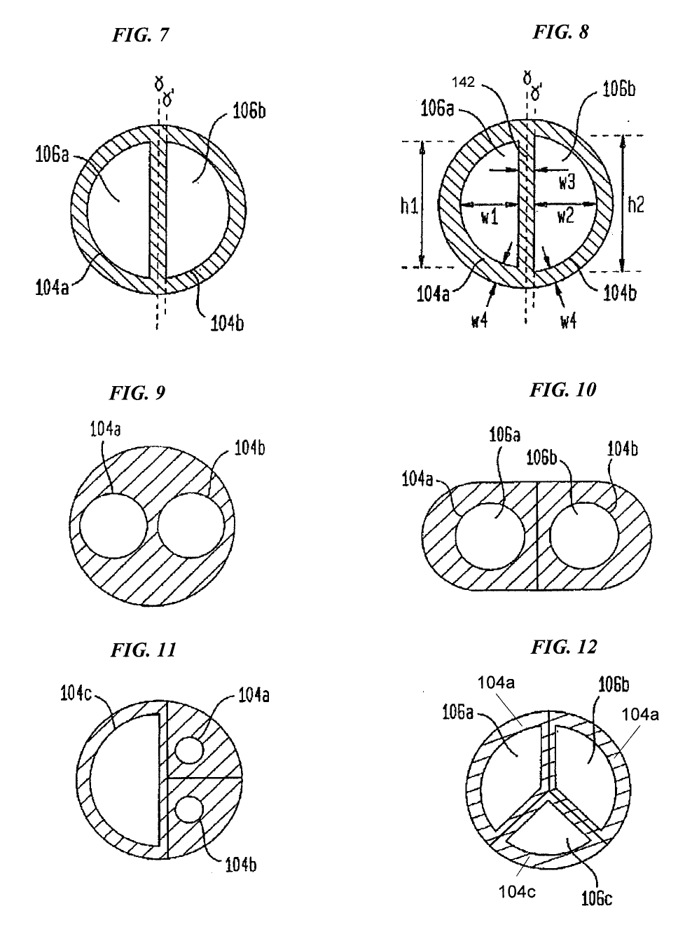

Each of the tubes 104 can have a cross-sectional shape, size, or area that can be the same or distinct from the catheter assembly 100 and/or the other tube. One embodiment of the catheter assembly 100 where the tubes 104 have different cross-sectional shapes is shown in FIG. 6, with the shorter tube 104b having a D-shaped cross-section and a D-shaped pathway 106b and the longer tube 104a having a substantially circular cross-section and a circular-shaped pathway 106a. A substantially flat-sided surface of the shorter, D-shaped tube 104b can be attached to a substantially flat, tangential surface of the longer, substantially circular tube 104a, as discussed further below. Examples of c1-c1 cross-sections (see FIGS. 2 and 4) are illustrated in FIGS. 7-12.

FIG. 7 shows a c1-c1 cross-section view of an embodiment showing a construction utilizing opposed D-shaped tubes 104 having substantially the same size of pathways 106. FIG. 8 is a c1-c1 cross-section view of another embodiment showing opposed D-shaped tubes 104 where one pathway 106a is of a smaller size (e.g., smaller cross-sectional area) than the other pathway 106b. Either of the pathways 106 can have a larger cross-sectional area than the other pathway, but the larger pathway is typically in the shorter, arterial lumen 104b because that is the one of the tubes 104 more prone to clogging in a hemodialysis setting, and a larger size pathway 106b can help reduce clogging. FIG. 9 is a c1-c1 cross-section view of an embodiment showing an elliptical construction utilizing individual, elliptical lumen pathways 106. FIG. 10 is a c1-c1 cross-section view of another embodiment showing another elliptical construction including two elliptical-shaped pathways 106 in the tubes 104. FIG. 11 is a cross-section view of an embodiment showing three tubes 104, at least one of which (here, tube 104c) having a different size and/or shape from at least one other tube (here, tubes 104a, 104b). FIG. 12 is a cross-section view of a variation of an embodiment showing three tubes 104 having pathways 106 of substantially the same size and shape, although they can have any same or different sizes and shapes.

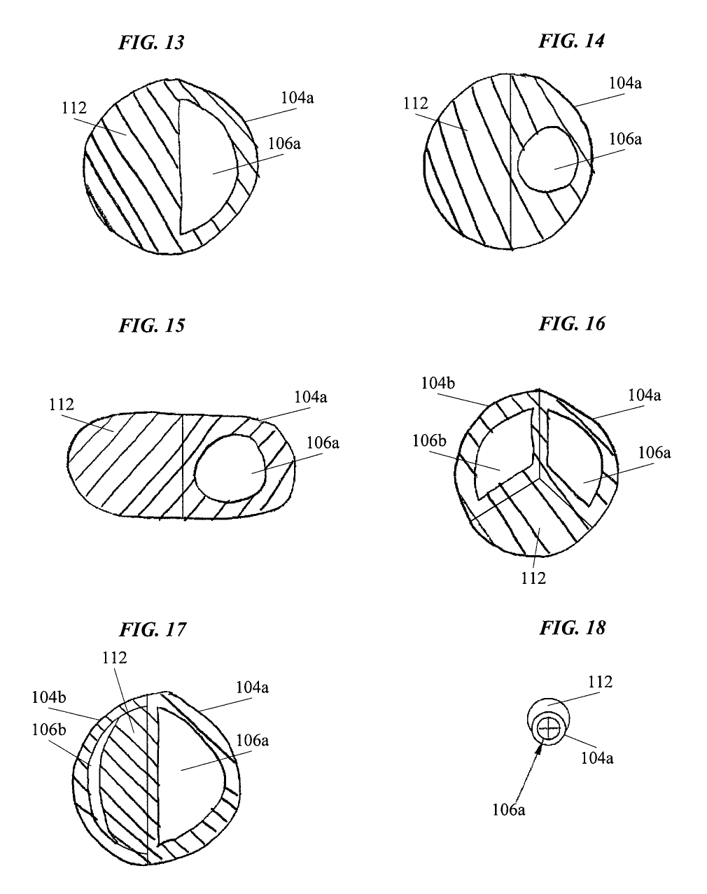

Examples of c2-c2 cross-sections (see FIGS. 2 and 4) are illustrated in FIGS. 13-18. FIG. 13 shows a c2-c2 cross-section view of an embodiment showing a construction having a D-shaped tube 104a and a D-shaped diverting structure 112 having substantially the same cross-sectional area as the longer lumen 104a. FIG. 14 is a c2-c2 cross-section view of an embodiment showing an elliptical construction utilizing a D-shaped diverting structure 112 and a D-shaped tube 104a having an individual, elliptical lumen pathway 106a. FIG. 15 is a c2-c2 cross-section view of another embodiment showing another elliptical construction including a D-shaped diverting structure 112 and an elliptical-shaped pathway 106a in the tubes 104a. FIG. 16 is a c2-c2 cross-section view of a variation of an embodiment showing three tubes 104 where two of the tubes 104a, 104b and the diverting structure 112 are each substantially the same size and shape, although they can have any same or different sizes and shapes. FIG. 17 is a c2-c2 cross-section view of an embodiment showing a construction having D-shaped tubes 104 and a D-shaped diverting structure 112 having smaller diameter and a smaller cross-sectional area than the shorter lumen 104b. FIG. 18 shows another view of a c2-c2 cross-section of an embodiment showing a construction having a circular-shaped longer tube 104a and pathway 106a and a crescent-shaped diverting structure 112 curved around the outside surface of the longer tube 104a.

Although the examples of c2-c2 cross-sections in FIGS. 13-18 show the diverting structure 112 as solid, as mentioned above the diverting structure 112 can include one or more hollow portions. In such a case, the catheter assembly's c2-c2 cross section could be, for example, as shown in FIGS. 7-12. As also mentioned above, the diverting structure 112 can have a variable diameter (as measured between an outside surface of the diverting structure 112 to the contacting surface 110 of the lumen 104 to which it is attached) along its longitudinal length and/or width, in which case its cross section can vary in size and/or shape along its longitudinal length and/or width.

Prior to the distal ends 108 of the catheter assembly 100 being inserted into a blood vessel, any or all portions of the tubes 104 can be coated with at least one agent, such as an antithrombotic agent, an antibacterial agent, and an anti-inflammatory agent. By way of non-limiting example, antithrombotic agents such as heparin and hirudin, citrate, antithrombin-heparin complex, and albumin heparin complex as well as anti-infective agents such as chlorohexidine, silver, antibiotics, and antiseptic agents can be used. The agent can be applied along the tubes 104 as a continuous coating or as a coating in discrete spots or regions. The spots or regions can vary in number, size, and distance from one another.

The catheter assembly 100 can be formed in a variety of ways. Additional information on catheters and manufacturing techniques can be found in commonly-owned, co-pending U.S. patent application Ser. No. ______ filed entitled “Fusion Manufacture of Multi-Lumen Catheters” and U.S. Patent Application Ser. No. 60/980,633 filed Oct. 17, 2007 entitled “Manufacture Of Split Tip Catheters,” which are hereby incorporated by reference in their entirety.

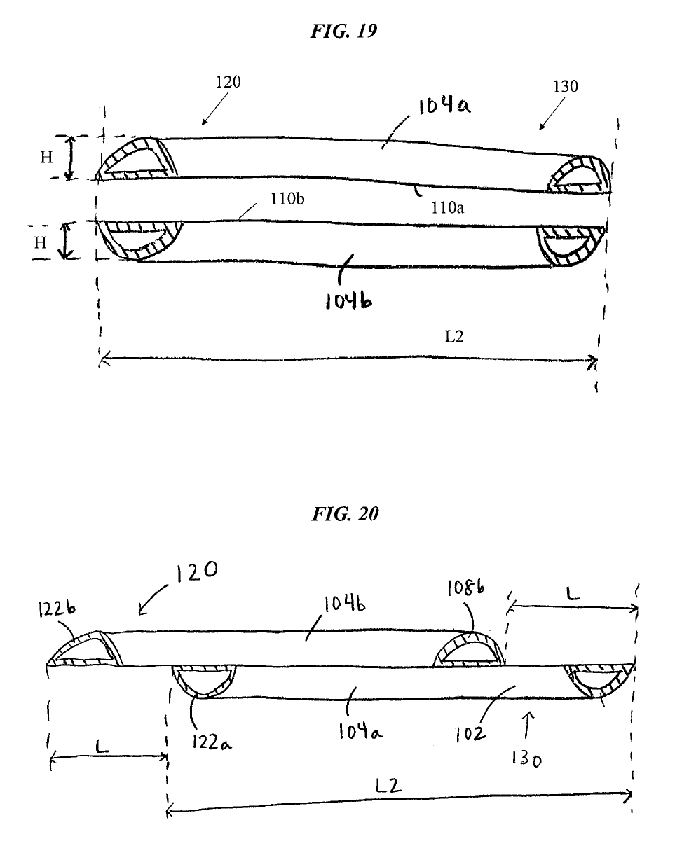

FIG. 19 shows one embodiment of the tubes 104 in an initial, unattached configuration (e.g., prior to their attachment to each other). Although the tubes 104 are shown having equal longitudinal lengths L2 and equal heights H, as mentioned above, the tubes 104 can have different longitudinal lengths and/or different heights. FIG. 20 illustrates the tubes 104 of FIG. 19, which have been attached together in a staggered, step configuration such that the distal end 108a of one of the tubes 104a extends the length L beyond the distal end 108b of the other tube 104b. By non-limiting example, the tubes 104 can be aligned while hot so at least one of the tubes 104 longitudinally extends beyond the other at the distal and/or proximal portions 130, 120 and can bond together in such a formation as they cool. Correspondingly, because the tubes 104 began in the initial, unattached configuration having equal longitudinal lengths L2, the proximal end 122b of the other tube 104b extends the length L beyond the proximal end 122a of the tube 104a. If the tubes 104 in the initial, unattached configuration have different lengths, the tubes 104 can be attached together (by attaching the entire longitudinal length of the shorter tube 104b to the longer tube 104a) such that the proximal ends 122 are aligned, as illustrated in FIG. 2.

An outer sheath can be added to at least a portion of the attached tubes 104, as discussed further below, and/or access ports can be added to the tubes 104 at the proximal portion 120. The access ports can include couplings, such as Luer-locks or the like, to couple the proximal portion 120 to a hemodialysis machine in which blood is circulated and purified.

The tubes 104 can be attached together in a variety of ways. For example, in one embodiment, the tubes 104 can be fused along at least a portion of their longitudinal lengths along substantially flat surfaces such as the contacting surfaces 10 of the tubes 104. Any fusion technique can be used, e.g., thermal fusion where elements to be joined (here, outer surfaces of the tubes 104) are heated along any or all portions of their perimeters or other areas to a desired temperature and fused together by application of a desired force and allowing them to melt/cool together. In another example embodiment, the tubes 104 can be fused together using a bonding technique, e.g., applying a bonding material such as an adhesive to one or more of the elements to be bonded and, if necessary, heating the bonding material to bond it to the elements. In some embodiments, the tubes 104 can be attached using any combination of heat fusion and bonding techniques.

Any portion of each of the tubes 104 can be attached together, e.g., 100% of the longitudinal lengths of one or both tubes 104, about 90% of the longitudinal lengths of one or both tubes 104, etc. If less than 100% of the tubes' longitudinal lengths are attached, the resulting structure can be used to create a split tip catheter, e.g., by adding one or more additional structures. As illustrated in FIG. 20, the tubes 104 are fused together along a portion of their lengths (equal to L2 minus L in this embodiment), leaving a freely floating, unattached portion (the distal tip portion 102) of length L. Alternatively, as further discussed below, the shorter tube 104b can be attached to the longer tube 104a to initially have a longitudinal length as long or longer than the longer tube 104a but subsequently be trimmed to provide the distal tip portion 102. Once the tubes 104 have desirable longitudinal lengths with respect to one another, a diverting structure can be attached to one of the tubes 104 as discussed above.

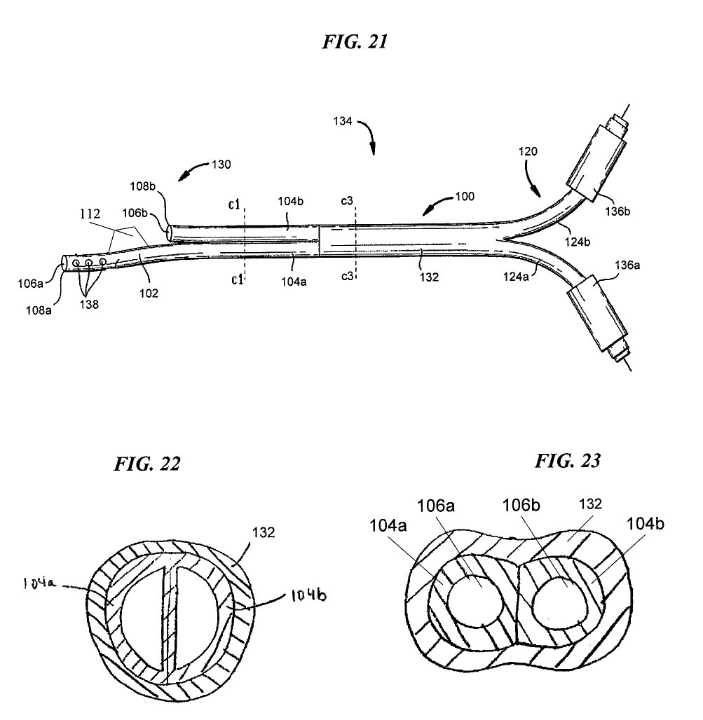

As mentioned above, an outer sheath, e.g., a fusing tube, can be added to partially or entirely cover and enclose the tubes 104 after they have been joined together. Such an outer sheath can encase the tubes 104 and smoothen any irregularities along the attached portion of the longitudinal lengths of the tubes 104. The outer sheath can be any shape and size and can be made of the same material as the tubes 104 or other material compatible with insertion into a blood vessel. The outer sheath can remain on or be removed from at least a portion of the catheter assembly 100. FIG. 21 illustrates an embodiment of the catheter assembly 100 partially encased by an outer sheath 132 and formed into a split tip catheter 134 having a split proximal portion 120. As illustrated in this embodiment, the outer sheath 132 terminates proximal to the distal ends 108 of the tubes 104 such that the distal tip portion 102 of the longer tube 104a is separate from the shorter tube 104b. Also shown in FIG. 21 is the proximal portion 120 of the catheter assembly 100 split into the separate lumen tips 124 that terminate with two access ports 136a, 136b.

Also illustrated in FIG. 21 are fluid passage holes (also called fluid openings) 138a, 138b, 138c (collectively, the fluid passage holes or openings 138) in fluid communication with the pathway 106a of their respective tube 104a to facilitate fluid removal (which typically occurs through the shorter tube 104b) and/or return (which typically occurs through the longer tube 104a), e.g., blood removal and return during hemodialysis. The fluid openings 138 can be of any number, shape, and size and can be located in a variety of places on any of the tubes 104, such as anywhere on their sides (e.g., not at the distal end 108). The fluid openings 138 can be formed in one or more of the tubes 104 prior and/or subsequent to joining the tubes 104. FIG. 21 shows the fluid openings 138 located on the facing surface 110a of the longer tube 104a. Alternatively, or in conjunction with the fluid passage holes 138, one or both of the distal ends 108 of the tubes 104 can be open (as shown in FIG. 21) to provide fluid passageways through the pathways 106. In addition to or instead of an agent coating the distal tip portion 102, the distal fluid openings 138 can be filled or covered with at least one fluid activated agent, such as the agents described above.

FIG. 22 shows a cross-section c3-c3 (see FIG. 21) of one embodiment of the outer sheath 132. The outer sheath 132 can be of any thickness and can have varying inner and outer shapes as well as varying inner and outer dimensions. The catheter assembly 100 can be constructed such that sheath material 132 encases the tubes 104 and no space remains between the sheath 132 and the tubes 104. For example, the sheath 132 can be fused to the tubes 104 or heat-shrunk around them. FIG. 23 shows another embodiment of the cross-section c3-c3 showing individual, elliptical tubes 104 having substantially circular cross-sectional pathways 106 inside the outer sheath 132.

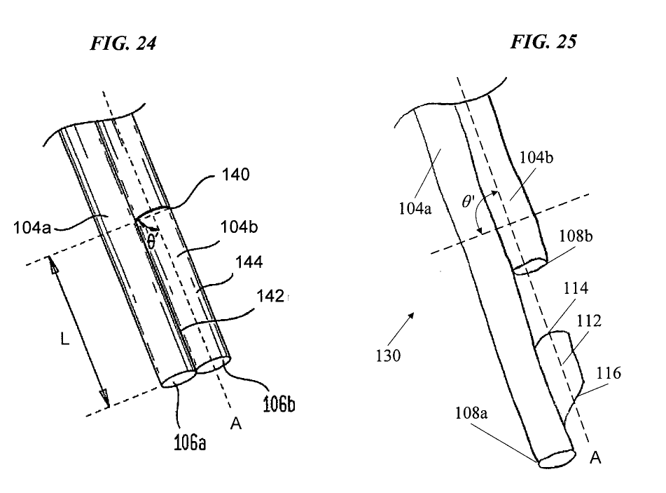

As mentioned above, if the shorter tube 104b initially has a longitudinal length as long or longer than the longer tube 104a (whether the tubes 104 were attached together to form a catheter assembly as described above or manufactured as a catheter assembly including multiple tubes 104 as discussed further below), the shorter tube 104b can be trimmed so the distal end 108a of the longer tube 104a is the length L beyond the distal end 108b of the shorter tube 104b. A tube 104 can be trimmed in a variety of ways. In a preferred example, one of the tubes 104b can be sliced (e.g., cut or scored) widthwise across its circumference at a cut point location 140, illustrated in FIG. 24. Then the length L of the shorter tube 104b can be trimmed from the catheter assembly 100. When the length L of the shorter tube 104b has been removed, a septum between the shorter tube's pathway 106b and the longer tube's pathway 106a can thereby be at least partially exposed. In one embodiment according to the invention, with reference to FIG. 7, the end portion of the catheter assembly 100 can be truncated by splitting the assembly along either a center line γ of the longitudinal axis or along an off-center longitudinal axis γ′. In certain applications, truncation along off-center line γ′ can be preferable because it preserves most or all the septum, while sacrificing part of the longer tube 104a (e.g., the part extending distally beyond the cut point 140 as shown in FIG. 24).

Referring again to FIG. 8 where the longer tube's pathway 106a is smaller than the shorter tube's pathway 106b, truncation of the end portion according the invention typically involves sacrificing part of the larger, shorter tube 104b. The catheter assembly 100 can again be split along an off-center longitudinal axis γ′, thereby preserving most or all a septum 142, sacrificing part of the shorter tube 104b (e.g., a segment 144 extending distally beyond the cut point 140). Following truncation, a diverting structure 112 can be attached to the longer tube 104a as discussed above and as illustrated in FIG. 25, where the cut point 140 is now the distal end 108b of the shorter tube 104b. FIG. 25 also illustrates an embodiment of the diverting structure 112 having curved but differently shaped proximal and distal ends 114, 116.

In certain applications it can be preferable to sacrifice the smaller tube 104b instead. In such instances, the truncation line can be moved to the other side of the septum 142.

Dimensions of the tubes 104a and 104b can vary between embodiments. In this example embodiment of FIG. 8, dimensions allow the catheter assembly 100 to be used with standard hemodialysis equipment and lumen tip segments. Maximum width w1 of the smaller lumen pathway 106a is about 0.06 in. and maximum width w2 of the larger lumen pathway 106b is about 0.08 in. The septum 142 has a width w3 of about 0.02±0.002 in., while the tubes 104 have an exterior width w4 of about 0.022±0.003 in. Maximum height h1 of the smaller pathway 106a is about 0.14 in. and maximum height h2 of the larger pathway 106b is about 0.15 in.

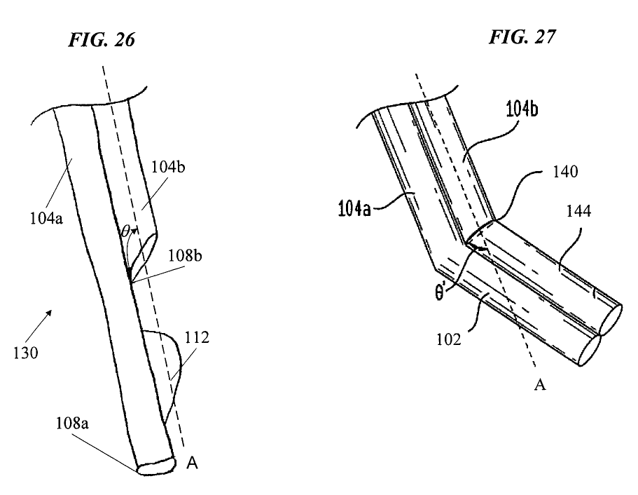

The cut distal end 140 of the shorter tube 104b can be trimmed in a perpendicular direction or a non-perpendicular direction with respect to the longitudinal axis A of the shorter tube 104b. FIG. 25 shows the cut distal end 108b trimmed in a perpendicular direction with respect to the axis A. Alternatively, FIG. 26 shows the cut distal end 108b trimmed in a non-perpendicular direction with respect to the axis A. The non-perpendicular direction can result in any non-zero angle θ between the cut distal end 108b and the axis A. As shown in FIGS. 25 and 26, the shorter tube 104b terminates proximal to the distal end 108a of the longer tube 104a.

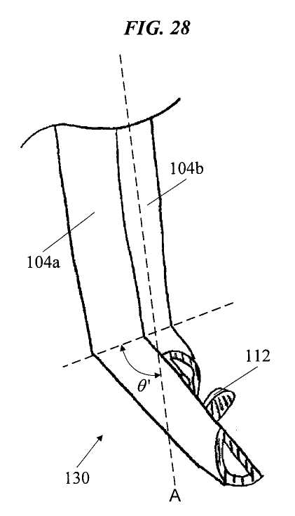

The distal portion 130 of the tubes 104 can have any configuration. The distal portion 130 of the tubes 104 can be substantially parallel to each other and to the longitudinal axis A, such as illustrated in FIGS. 24 and 25 where an angle θ′ with respect to the axis A equals ninety degrees. Alternatively, as shown in FIGS. 27 and 28, the distal portion 130 of the tubes 104 can have an angled tip configuration where the distal portion 130 of the tubes 104 are substantially parallel to each other but at an angle θ′ with respect to the longitudinal axis A, where the angle θ′ is less than ninety degrees. The angled tip configuration can be formed before the tubes 104 are attached together (e.g., by providing tubes 104 in an initial configuration having angled distal portions) or after (e.g., by heating the tubes 104).

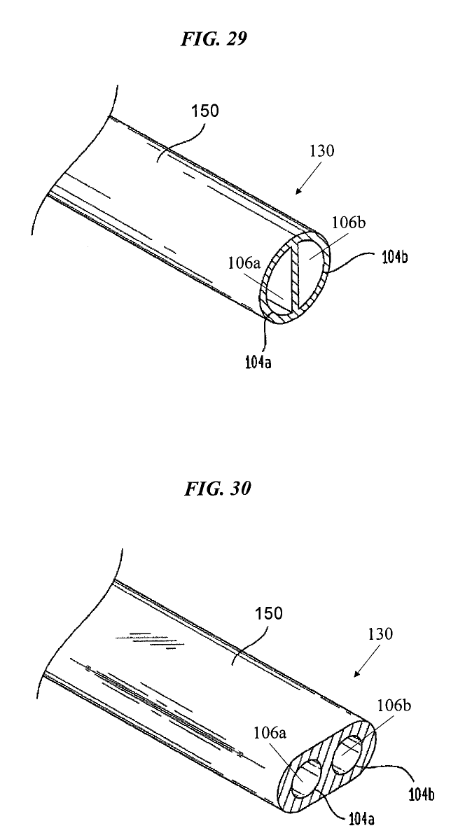

As an alternative to providing the tubes 104 in an initial, unattached configuration and attaching the tubes 104 together, the catheter assembly 100 can be formed by providing a multi-lumen catheter body in an initial untrimmed configuration and optionally trimming at least one of the catheter body's lumens as described above. A flow diverting structure can then be attached to the catheter assembly 100 as described above. FIG. 29 shows an embodiment of a circular catheter body 150 in an initial configuration having two D-shaped tubes 104a, 104b with D-shaped pathways 106a, 106b. FIG. 30 shows another, elliptical catheter body 150 in an initial configuration with circular tubes 104a, 104b with circular pathways 106a, 106b. Although the lumens 106 are shown having equal lengths at the distal end 130 in FIGS. 29 and 30, the lumens 106 in the catheter body 150 can have different lengths in this initial configuration at the proximal and/or distal portions 120, 130. If one of the lumens 106 extends beyond the other at the distal portion 130 such that a flow diverting structure can be attached to its outside surface, then at least one of the catheter body's lumens can, but need not, be trimmed.

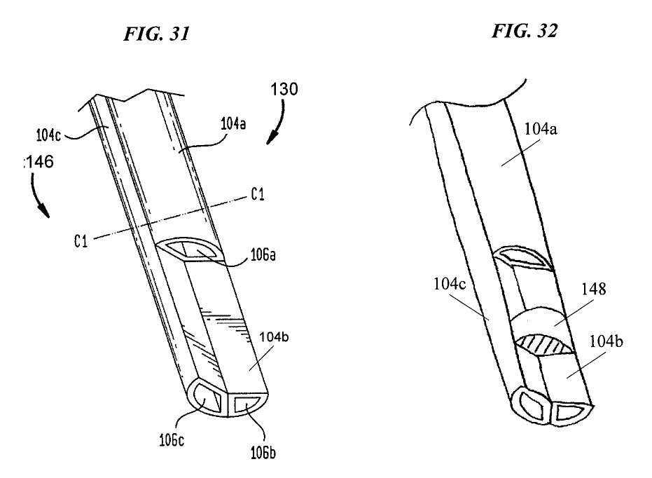

FIGS. 1-10, 13-15, and 17-30 illustrate double lumen configurations, but the catheter devices and methods described herein can apply to any multi-lumen configuration. For example, FIG. 31 shows an embodiment of a catheter assembly 146 having first, second, and third tubes 104a, 104b, 104c, each having respective pathways 106a, 106b, 106c. The catheter assembly 146 can have any c1-c1 cross-sectional configuration, and in this example is shown having the one of FIG. 12. The first tube 104a in this example has a shorter longitudinal length at the distal portion 130 than the second and third tubes 104b, 104c by having an overall shorter longitudinal length, being so arranged in a staggered, step configuration when attached to the second and third tubes 104b, 104c, and/or being trimmed. FIG. 32 shows the catheter assembly 146 of FIG. 31 where a flow diverting structure 148 has been attached, in any away described above, to outside surfaces of the second and third tubes 104b, 104c.

Other embodiments are within the scope of the following claims.

All publications, patent documents and other information sources identified in this application are hereby incorporated by reference.

What is claimed is:

1. A method of forming a fixed tip catheter, comprising:
providing first and second catheter tubes, a distal end of the first catheter tube extending a longitudinal length beyond a distal end of the second catheter tube; and
attaching a flow diverting structure to an outside surface of the first catheter tube between the distal ends of the first and second catheter tubes.

2. The method of claim 1, wherein the step of attaching a flow diverting structure further comprises fusing the flow diverting structure to the first catheter tube.

3. The method of claim 1, wherein the step of attaching a flow diverting structure further comprises gluing the flow diverting structure to the first catheter tube.

4. The method of claim 1, wherein the step of attaching a flow diverting structure further comprises orienting the flow diverting structure on the outside surface of the first catheter tube to intersect a longitudinal axis of the second catheter tube.

5. The method of claim 1, further comprising forming at least one fluid passage hole in a side of each of the catheter tubes.

6. The method of claim 1, coating at least a portion of the first catheter tube with at least one agent selected from the group of antithrombotic agents, antibacterial agents, anti-inflammatory agents.

7. The method of claim 1, wherein the flow diverting structure is composed of a material different than a material of the first catheter tube.

8. The method of claim 7, wherein the flow diverting structure is composed of a material with a durometer that differs from that of the first catheter tube.

9. The method of claim 1, wherein a diameter of the flow diverting structure does not exceed a diameter of the second catheter tube.

10. The method of claim 1, wherein lumens of the first and second inner catheter tubes each have double D-shaped configurations.

11. The method of claim 1, wherein the first and second inner catheter tubes have different cross-sectional areas.

12. The method of claim 1, wherein the first and second catheter tubes have different cross-sectional shapes.

13. A method of forming a fixed tip catheter, comprising:
providing an elongate catheter body comprising at least a first inner lumen and a second inner lumen extending longitudinally through the catheter body;
removing a distal portion of the catheter body to form a first lumen tip segment such that the first inner lumen extends longitudinally beyond a distal end of the second inner lumen; and
attaching a flow diverting structure to an outside surface of the first lumen tip segment.

14. The method of claim 13, wherein the step of attaching a flow diverting structure further comprises fusing the flow diverting structure to the first lumen tip segment.

15. The method of claim 13, wherein the step of attaching a flow diverting structure further comprises gluing the flow diverting structure to the first lumen tip segment.

16. The method of claim 13, wherein the step of attaching a flow diverting structure further comprises attaching the flow diverting structure a distance from the distal end of the second inner lumen.

17. The method of claim 13, wherein the step of attaching a flow diverting structure further comprises orienting the flow diverting structure on the outside surface of the first lumen to intersect a longitudinal axis of the second inner lumen.

18. The method of claim 13, wherein the step of removing a distal portion of the catheter body further comprises partially slicing the catheter body in a non-perpendicular direction with respect to a longitudinal axis of the catheter body.

19. The method of claim 13, wherein the step of removing a distal portion of the catheter body further comprises truncating the catheter body at a truncation point such that at least a portion of the septum is retained by the first lumen tip segment.

20. A method of forming a fixed tip catheter, comprising:
splitting a distal end of a catheter body having two or more lumens at a septum dividing two of the lumens to isolate a first distal end lumen tube;
truncating the catheter body such that the first distal end lumen tube is formed and has a length that extends beyond a truncation point; and
attaching at a distance beyond the truncation point a flow diverting structure to at least a portion of the septum retained on the first distal end lumen tube.

21. The method of claim 20, further comprising further truncating the distal end of the catheter body to isolate a third lumen.

22. A method of forming a fixed tip catheter, comprising:
removing a partial length of a tube included in a catheter body to expose a septum between the tube and another tube included in the catheter body, wherein each tube defines a separate fluid pathway extending longitudinally through the catheter body; and
attaching a flow diverting structure to the septum such that the flow diverting structure is configured to divert fluid flowing through the pathway of the tube that was partially removed.

23. The method of claim 22, wherein the step of attaching a flow diverting structure further comprises attaching the flow diverting structure a distance from a distal end of the tube that was partially removed.

24. The method of claim 22, wherein the step of attaching a flow diverting structure further comprises orienting the flow diverting structure on the septum to intersect a longitudinal axis of the fluid pathway of the tube that was partially removed.

25. The method of claim 22, wherein the tubes have different cross-sectional areas.

26. A method of forming a fixed tip catheter, comprising:
providing a first catheter tube having a substantially D-shaped cross-section and a second catheter tube having a substantially D-shaped cross-section;
attaching at least a portion of longitudinal lengths of the first catheter tube and the second catheter tube along flat surfaces of the first catheter tube and the second catheter tube to form a dual lumen catheter assembly such that the first catheter tube extends longitudinally beyond the second catheter tube; and
attaching a flow diverting structure to a portion of the flat surface of the first catheter tube that extends longitudinally beyond the second catheter tube.

27. The method of claim 26, wherein the step of attaching a flow diverting structure further comprises attaching the flow diverting structure a distance from a distal end of the second catheter tube.

28. The method of claim 26, wherein the step of attaching a flow diverting structure further comprises orienting the flow diverting structure on the first catheter tube to intersect a longitudinal axis of the second catheter tube.

29. The method of claim 26, wherein the step of attaching a portion of longitudinal lengths further comprises fusing the tubes together along at least about 70% of the longitudinal length of at least one of the tubes.

30. The method of claim 26, wherein the step of attaching at least a portion of longitudinal lengths further comprises heat bonding the first catheter tube and the second catheter tube.

31. The method of claim 26, wherein the step of attaching at least a portion of longitudinal lengths further comprises adhesive or chemical reaction bonding the first catheter tube and the second catheter tube.

32. The method of claim 26, further comprising removing a portion of the assembly to form a first lumen tip segment such that the first catheter tube extends longitudinally beyond the second catheter tube.

33. The method of claim 26, further comprising fusing together two tubes of different longitudinal lengths such that the first catheter tube extends longitudinally beyond the second catheter tube.

34. The method of claim 26, further comprising encasing the assembly to smoothen any irregularities along the attached portion of the longitudinal lengths.

35. A method of forming a fixed tip catheter, comprising:
providing a first catheter tube having a cross-section including at least one substantially flat-sided surface and a second catheter tube having a cross-section including at least one substantially flat-sided surface;
attaching at least a portion of the substantially flat-sided surfaces together to form a catheter assembly such that a distal portion of the first catheter tube extends beyond a distal portion of the second catheter tube when their substantially flat-sided surfaces are attached; and
attaching a flow diverting structure to a portion of the substantially flat-sided surface of the distal portion of the first catheter tube.

36. The method of claim 35, wherein the step of attaching a flow diverting structure further comprises attaching the flow diverting structure a distance from a distal end of the second catheter tube.

37. The method of claim 35, wherein the step of attaching a flow diverting structure further comprises orienting the flow diverting structure on the first catheter tube to intersect a longitudinal axis of the second catheter tube.

38. The method of claim 35, wherein the step of attaching a portion of the substantially flat-sided surfaces together further comprises heat bonding the first catheter tube and the second catheter tube.

39. The method of claim 35, wherein the step of attaching a portion of the substantially flat-sided surfaces together further comprises adhesive or chemical reaction bonding the first catheter tube and the second catheter tube.

40. The method of claim 35, further comprising encasing the catheter assembly to smoothen any irregularities along the attached surfaces.

41. A method of forming a fixed tip catheter, comprising:
attaching two tubes together along at least a portion of substantially flat surfaces of respective longitudinal lengths of the tubes;
orienting the tubes such that a distal portion of one tube extends longitudinally beyond a distal portion of the other tube; and
attaching a flow diverting structure to an outside surface of the distal portion of the tube that extends longitudinally beyond the distal portion of the other tube.

42. The method of claim 41, wherein the step of attaching the two tubes together further comprises attaching the tubes along substantially planar edges of respective D-shaped cross-sections of the tubes.

43. The method of claim 41, further comprising allowing proximal portions of the tubes to remain unattached from each other.

44. The method of claim 41, further comprising fusing together two tubes of different longitudinal lengths such that the distal portion of one tube extends longitudinally beyond the distal portion of the other tube.

45. The method of claim 41, wherein the step of attaching two tubes together further comprises fusing the tubes together along at least about 70% of the longitudinal length of at least one of the tubes.
